(19) United States
(12) Patent Application Publication
(10) Pub. No.: US 2021/0084880 A1
(43) Pub. Date: Mar. 25, 2021

(54) GATED FISHING HOOK

(71) Applicant: Hunter Michael Faust, Statesville, NC (US)

(72) Inventor: Hunter Michael Faust, Statesville, NC (US)

(21) Appl. No.: 16/582,606

(22) Filed: Sep. 25, 2019

(51) Int. Cl. A01K 97/18; A01K 83/06

(52) U.S. Cl. CPC A01K 97/18; A01K 83/06

(57) ABSTRACT

A gated fishing hook includes a shaft portion a first terminal end having a line eye. A hook portion extends from the shaft portion and includes a second terminal end having a point. A notch is defined on an inner surface of the hook portion below the second terminal end. A gate includes a looped wire having a first end coupled to a connection point disposed in between the shaft portion and the hook portion. The gate extends towards the notch and includes a bend spring biased within the notch. The gate is configured to pivot downward against the spring bias when a fish bites the hook, capturing a portion of a fish's lip in between the hook portion and the gate.

### BACKGROUND OF THE INVENTION

The present invention relates to a fishing hook and, more particularly, to a fishing hook that safely catches fish and prevents further injury during removal.

In recent years in the field of sport fishing, much has been done to promote the concept of releasing fish after they have been caught by the angler, rather than killing the fish for food or simply out of carelessness. This concept promotes fishing as a sport and fish as a resource, rather than merely as a source of food for the angler.

However, in order to successfully release a fish without harm, some care must be taken by the fisherman and a number of factors must be taken into consideration. Delayed mortality is often a possibility not readily apparent or measurable, but which can take its toll on the fish population. Delayed mortality occurs when a fish is released and swims away, but dies a few hours or days later due to the injuries received when caught or during handling. Such delayed mortality can be a result of many factors including rough handling of the fish after the catch, harm to the fish by the type of equipment used for the catch, and harm caused by the act of removing the fish from the hook.

Some products have appeared on the market to treat the fish prior to their release to minimize the possibility of disease caused by rough handling, and the use of artificial bait helps to minimize the harmful effect caused by the equipment used, since seldom does the fish actually swallow the artificial bait, instead being hooked in the fleshy or bony portion of the mouth enabling the hook to be easily removed without too great danger of harm to the fish.

However, live bait is often used by fishermen because of its greater fish catching ability. But the use of live bait increases the risk that the fish will swallow the bait. When this happens, removal of the hook from the fish very often will seriously harm the fish, either killing the fish immediately, or greatly increasing the chances that the fish will die soon after he is returned to the water.

As can be seen, there is a need for a fishing hook that safely catches fish and prevents further injury during removal.

### SUMMARY OF THE INVENTION

In one aspect of the present invention, a gated fishing hook comprises: a shaft portion comprising a first terminal end comprising a line eye; a hook portion extending from the shaft portion and comprising a second terminal end comprising a point, wherein a notch is defined on an inner surface of the hook portion below the second terminal end; and a gate comprising a looped wire having a first end coupled to a connection point disposed in between the shaft portion and the hook portion, wherein the gate extends towards the notch and comprises a bend spring biased within the notch, wherein the gate is configured to pivot downward against the spring bias when a fish bites the hook, capturing a portion of a fish's lip in between the hook portion and the gate.

In another aspect of the present invention, a gated fishing hook comprises: a shaft portion comprising a first terminal end comprising a line eye; a hook portion extending from the shaft portion and comprising a second terminal end comprising a point, wherein a notch is defined on an inner surface of the hook portion below the second terminal end; and a gate comprising a looped wire having a first end coupled to a connection point disposed in between the shaft portion and the hook portion, wherein the looped wire comprises a first bend in a first direction downward running from the connection point and a second bend angled towards the notch, wherein the looped wire comprises a bend spring biased within the notch, wherein the gate is configured to pivot downward against the spring bias when a fish bites the hook, capturing a portion of a fish's lip in between the hook portion and the gate.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a bottom front perspective view of an embodiment of the present invention;

FIG. 3 is a top front perspective view of an embodiment of the present invention;

FIG. 4 is a front view of an embodiment of the present invention; and

FIG. 5 is a side view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a fishing hook that utilizes a gate to safely catch fish. The fishing hook of the present invention does not allow the hook to travel to the fish's vital organs. Instead the hook clips around the lip locking the hook into place. The present invention creates less of a puncture wound in the fish's mouth, allowing for true catch and release creating a scenario that saves the fish lives.

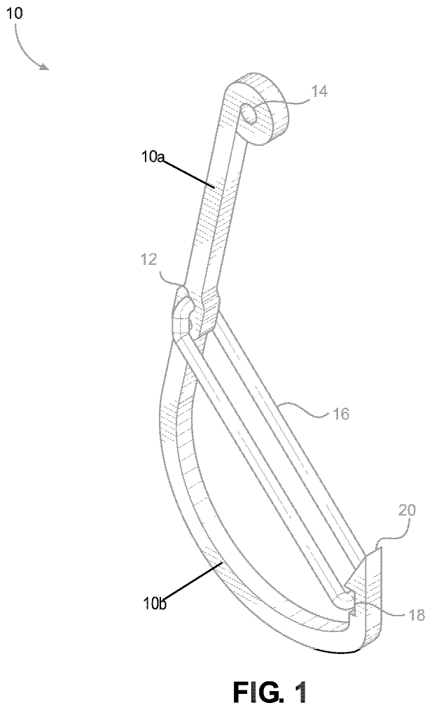

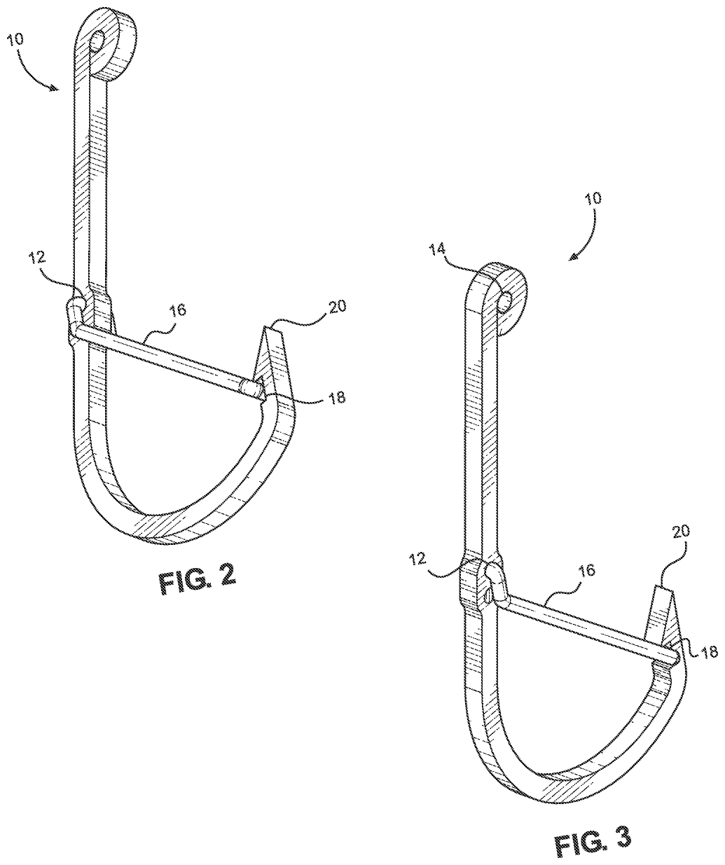

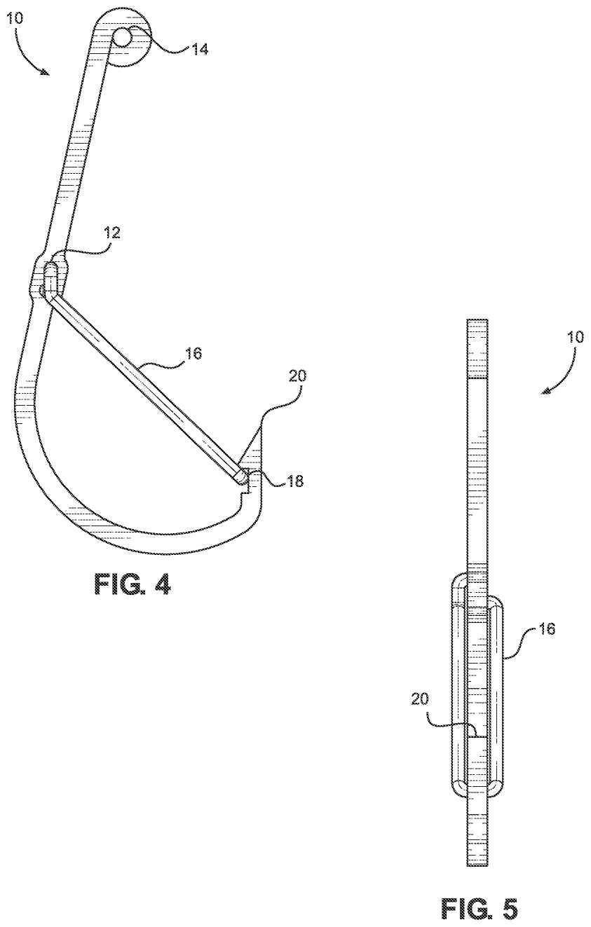

Referring to FIGS. 1 through 5, the present invention includes a gated fishing hook 10. The gated fishing hook 10 includes a shaft portion 10a with a first terminal end having a line eye 14. A hook portion 10b extends from the shaft portion 10b and includes a second terminal end having a point 20. A notch 18 is defined on an inner surface of the hook portion 10b below the second terminal end. A gate 16 includes a looped wire having a first end coupled to a connection point 12 disposed in between the shaft portion 10a and the hook portion 10b. The gate 16 extends towards the notch 18 and includes a bend spring biased within the notch 18. The gate 16 is configured to pivot downward against the spring bias when a fish bites the hook 10, capturing a portion of a fish's lip in between the hook portion 10b and the gate 16.

As mentioned above, the gate 16 is made of a looped wire. The looped wire may be an endless looped wire in which the gate 16 has a second end coupled to the connection point 12. In certain embodiments, the connection point 12 includes a first opening on a first side and a second opening on a second side opposite the first side. The first end of the gate 10 is disposed within the first opening and the second end of the gate 10 is disposed within the second opening. The looped wire of the gate 16 may further include a first bend in a first direction downward running from the connection point 12 and a second bend angled towards the notch 18. The bends may provide for the spring bias.

A method of using the present invention may include the following. The fisherman ties the fishing line onto the line eye 14 of the hook 10. The fisherman casts the hook 10 into the water. When a fish takes the bait, the fisherman “sets” the hook 10. Upon the setting of the hook 10, the gate 16 opens and allow the fish's lip to slide onto the pointed tip 20 and down the hook portion 10b allowing the gate 16 to firmly set behind the fish's lip.

It should be understood, of course, that the foregoing relates to exemplary embodiments of the invention and that modifications may be made without departing from the spirit and scope of the invention as set forth in the following claims.

What is claimed is:

1. A gated fishing hook comprising:
a shaft portion comprising a first terminal end comprising a line eye;
a hook portion extending from the shaft portion and comprising a second terminal end comprising a point, wherein a notch is defined on an inner surface of the hook portion below the second terminal end; and
a gate comprising a looped wire having a first end coupled to a connection point disposed in between the shaft portion and the hook portion, wherein the gate extends towards the notch and comprises a bend spring biased within the notch, wherein
the gate is configured to pivot downward against the spring bias when a fish bites the hook, capturing a portion of a fish's lip in between the hook portion and the gate.

2. The gated fishing hook of claim 1, wherein the gate comprises a second end coupled to the connection point.

3. The gated fishing hook of claim 2, wherein the connection point comprises a first opening on a first side and a second opening on a second side opposite the first side, wherein the first end of the gate is disposed within the first opening and the second end of the gate is disposed within the second opening.

4. The gated fishing hook of claim 1, wherein the looped wire of the gate comprises a first bend in a first direction downward running from the connection point and a second bend angled towards the notch.

5. A gated fishing hook comprising:
a shaft portion comprising a first terminal end comprising a line eye;
a hook portion extending from the shaft portion and comprising a second terminal end comprising a point, wherein a notch is defined on an inner surface of the hook portion below the second terminal end; and
a gate comprising a looped wire having a first end coupled to a connection point disposed in between the shaft portion and the hook portion, wherein the looped wire comprises a first bend in a first direction downward running from the connection point and a second bend angled towards the notch, wherein the looped wire comprises a bend spring biased within the notch, wherein
the gate is configured to pivot downward against the spring bias when a fish bites the hook, capturing a portion of a fish's lip in between the hook portion and the gate.

6. The gated fishing hook of claim 5, wherein the gate comprises a second end coupled to the connection point.

7. The gated fishing hook of claim 6, wherein the connection point comprises a first opening on a first side and a second opening on a second side opposite the first side, wherein the first end of the gate is disposed within the first opening and the second end of the gate is disposed within the second opening.
